(19) United States
(12) Patent Application Publication
(10) Pub. No.: US 2018/0322544 A1
(43) Pub. Date: Nov. 8, 2018

(54) Unique indicia based consumer Concierge system

(71) Applicant: Pasquale Vincent Costa, Concord, MA (US)

(72) Inventor: Pasquale Vincent Costa, Concord, MA (US)

(21) Appl. No.: 14/545,392

(22) Filed: Apr. 29, 2015

(51) Int. Cl. G06Q 30/02; G06K 7/14; H04M 1/725; G06Q 30/06

(52) U.S. Cl. CPC G06Q 30/0281; G06Q 30/0641; H04M 1/72522; G06K 7/1417

(57) ABSTRACT

The disclosed system provides all that a Service Provider, such as a merchant, retailer, restauranteur, travel agent, doorman, security guard and the like, needs to set up and manage a concierge-type system to provide convenient personalized service to respective users. The System serves the needs of both system users and respective service providers. It is a universal system that is applicable to any and all stores and service places (stores, restaurants, hair salons, auto repair centers, etc. etc.). The system can be scaled up very quickly since all system components are deliverable digitally and can be managed remotely. Such components, as an example, might include providing the user and service provider; with apps for the System User's phone, tablet or pc, downloadable from an app store or the like (once the system user has the app on their device, any service provider can provide interactive personal concierge service to that user by becoming a participating service provider); software for the service provider's management computer; apps for the service providers designated concierge persons' Digital Devices; and Unique Identifier Kiosk Tags, displays, markers, etc. for each of the service provider's locations.

### FIELD OF APPLICATION

This invention relates primarily to obtaining services with the assistance of a third party, such as a concierge, or the like, that is not necessarily the provider of the service; and, more particularly, to facilitating the interaction and/or co-action between the party providing the service and the party seeking the service.

### DESCRIPTION OF THE PRIOR ART

Concierge services are often provided in hotels where the concierge, responds to requests by hotel guests, person to person and/or by telephone, for services such as theater tickets, restaurant suggestions, locations of places of interest to tourists, and the like. Technology has, however, provided some electronic concierge-like services, such as shown and described: in U.S. Pat. No. 7,064,652 for “Multimodal Concierge For Secure and Convenient Access To A Home or Building” which is only for providing access to a home or building by way of an electronic Lock system; and in U.S. Pat. No. 8,280,009 for “Consumer Electronic Registration, Control and support Concierge Device and Method” which is directed to remote access to appliances and the like within a home.

U.S. Pat. No. 8,028,246 for “Concierge-Shopping Assistant” provides only on-line electronic information for the end user without any person to person contact. While U.S. Pat. No. 8,731,984 for “Global Concierge” is mostly directed to travel and related items, such as hotels, restaurants, rental cars, gifts and show tickets and the like, with very broad reference to merchants, and payments but which do not provide sufficient detail to render them enabling.

### SUMMARY OF THE INVENTION

Therefore it is an object of the invention to provide a new and novel concierge system.

It is another object of the invention to provide a new and novel Unique Indicia Based Consumer Concierge System.

It is still another object of this invention to provide a new and novel consumer/merchant shopping arrangement.

It is yet another object of this invention to provide a new and novel arrangement between a party seeking a service and a service provider.

It is still another object of this invention to provide a new and novel arrangement to facilitate entry into a secure building, office or place where a first party and a second party are to have a meeting.

It is still another object of this invention to provide a new and novel arrangement to facilitate entry into a secure building, office or place where a first party and a second party are to have a business meeting.

It is yet still another object of this invention to provide a new and novel system for making reservations at a place of business, such as a restaurant, theater, movie, transportation service, and the like.

It is yet still another object of this invention to provide a new and novel system for making reservations at a place of business, such as a restaurant, theater, movie, transportation service, and the like and to effect payment for the services rendered, or to be rendered.

### BRIEF DESCRIPTION OF THE DRAWINGS

Some of the objects of the invention have been set out above. Other objects and advantages of the invention will appear as the description proceeds when taken in conjunction with the following drawings in which:

FIG. 1 is a schematic of a business establishment that may utilize the instant invention;

FIG. 2 is a showing of a computer monitor and keyboard to be located in the business establishment to effect use of the instant invention;

FIG. 3 illustrates some of the instant inventions components that might be utilized by personnel of the business establishment to facilitate their use of the instant invention;

FIG. 4 depicts a representation of a person who will be seeking a service through a service provider according to the instant invention;

FIG. 5 shows representations of some components (a smartphone, tablet and PC) usable by the person of FIG. 4 to effect communication with a service provider according to the instant invention;

FIG. 6 shows the person of FIG. 4 with a smartphone and connected to the UCIS of the instant invention;

FIG. 7 shows the person of FIG. 4 at a UICS Kiosk of the instant invention in a retail store;

FIG. 8 shows the person of FIG. 4 in contact with a salesperson inside the retail store of FIG. 7 according to the instant invention;

FIG. 9 is a representation of a secure building;

FIG. 10 is a schematic of a security guard within the secure building of FIG. 9;

FIG. 11 is a representation of a host inside the secure building of FIG. 9 inviting a guest to a meeting inside the secure building according to the instant invention;

FIG. 12 depicts a guest that has been invited to meet with the host of FIG. 11 according to the instant invention; and

FIG. 13 illustrates the UICSS Kiosk of the instant invention within the secure building of FIG. 9.

### DESCRIPTION OF THE INVENTIVE EMBODIMENTS

The Unique Indicia Based Consumer Concierge System (UICS) provides all that a Service Provider, such as a merchant, retailer, restarenture, travel agent, doorman, security guard and the like, needs to set up and manage a concierge-type system to provide convenient personalized service to its respective users.

The UICS provides the following to the registered user and registered Service Provider. The System serves the needs of both system Users and their respective Service Providers. It is a universal system that is applicable to any and all stores and service places (stores, restaurants, hair salons, auto repair centers, etc. etc.). The System can be scaled up very quickly since all system components are deliverable digitally and can be managed remotely. Such components, as an example might include providing the following items to the registered User and registered Service Provider:

Apps for the System User's phone, tablet or pc, downloadable from an app store or the like (Once System User has the app on their device, any Service Provider can provide interactive personal concierge service to that User by becoming a participating Service Provider);

Software for the Service Provider's management computer;

Apps for the Service Providers Designated Concierge persons' Digital Devices; and

Unique Identifier Kiosk Tags, displays, markers, etc. for each of the Service Provider's locations.

Thus it can be seen that the cost to equip each System User and/or Service Provider is miniscule.

The UICS Consumer App will also allow for any information exchange between a System User and a Service Provider (similar to text messaging but all handled by the UICS Computer System). It can execute any commercial transaction including sales of products/services. Products can be selected, ordered, shipped to a desired location or held at the retail store or other location for later pickup. System Users can also use their UICS app for credit card payment for in-store purchases.

### UICS Consumer/Retailer Inventive Embodiment

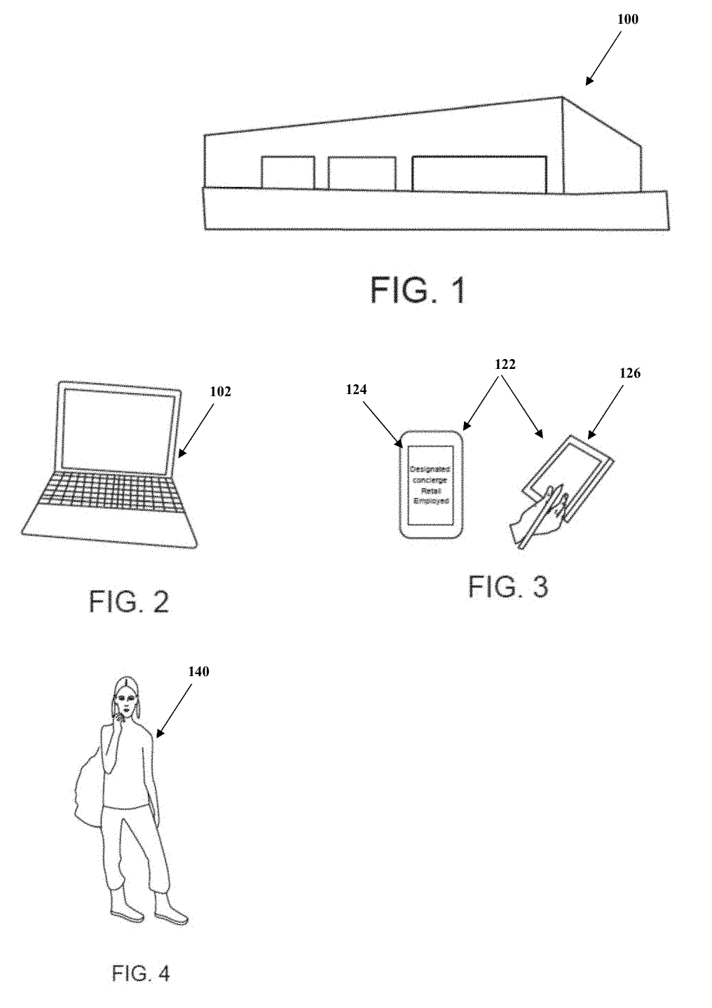

The following is an example of a Consumer/Retailer embodiment of the instant Unique Indicia Based Concierge System (UICS) of (FIGS. 1-8).

A UICS Computer 102 (FIG. 2) may be of the type considered to be “in the cloud” and/or it may otherwise be connected to Consumers, and third parties such as Retailers, Devices, etc. by WI-FI, cell or other internet connection.

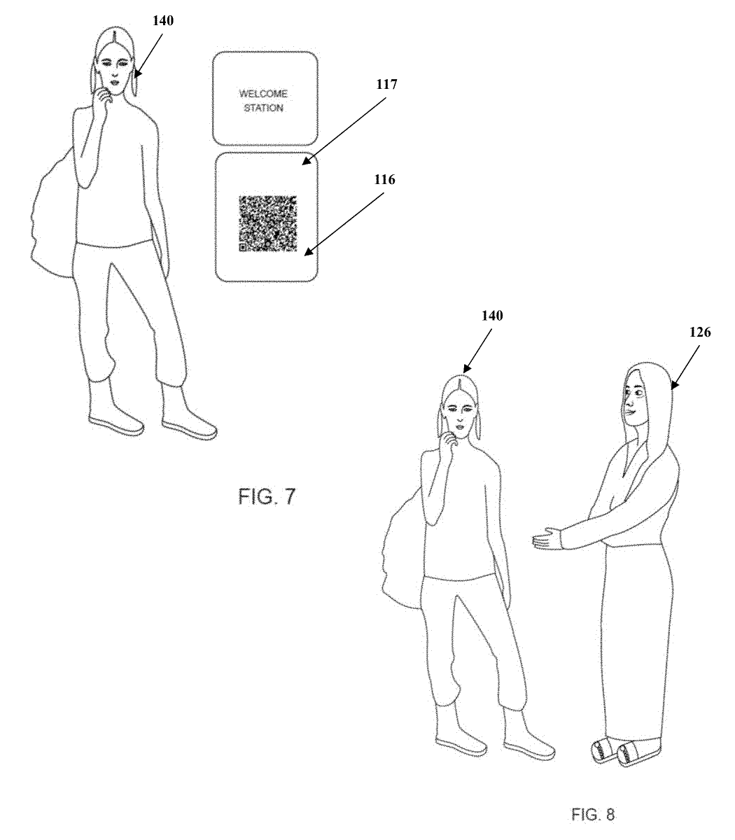

Retailers, such as those within the business establishment (retail store) 100 of FIG. 1 participating in the UICS System do so by downloading the UICS Concierge Software to their Store Computer 102 (FIG. 2). A Unique Indicia Store Tag 110 (FIG. 7) is sent digitally to Participating Retailers. An example of a Unique Indicia Based Tag 110 is one with a Data Matrix 2 Dimensional Bar Code containing a Unique ID number representing the Unique Retailer Store ID which is to be displayed on a Kiosk 112. The Store Tag Kiosk 112 might be positioned in a prominent location, such as near the store entry, to let their customers know that the store is participating in the UICS system. The UICS Concierge Store Tag 110 can be printed and/or otherwise displayed digitally on Kiosk 112. It should be understood that a kiosk 112 with specific Tag ID's 110 may be placed at one or more departments within retail establishment 100 and/or for specific manufacturers of merchandise being sold. It should be further understood that while the tag 110 display is shown as a Data Matrix type code that other codes, pertinent to the store, department, merchandise, etc. may just as well be used.

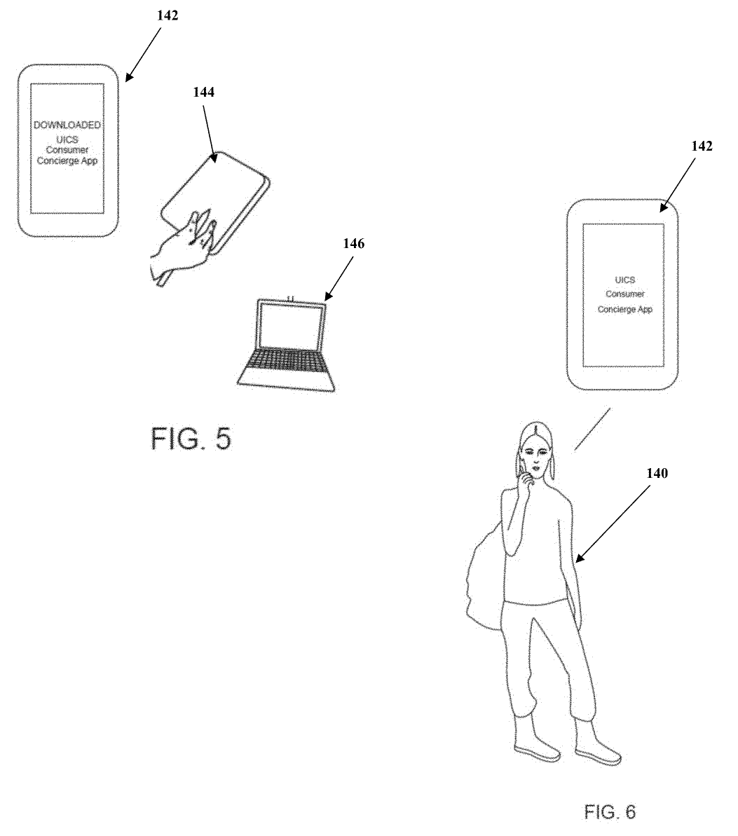

The participating retailer also designates selected employees to be Concierge Salespersons 120 (FIG. 7). The designated employees 120 thereafter download the UICS Concierge Salesperson App from App Store to their digital device(s) 122 (FIG. 3) which may include a smartphone 124 and/or a tablet 126, or similar device.

A Consumer 140 (FIGS. 1 and 6-8), participating in the UICS, downloads the concierge App (or other powered app containing the UICS Concierge Feature); and, if the Consumer intends to utilize UICS for shopping may select one or more retailers from a list of participating retailers. Customer 140 thereafter may either schedule a visit to a specific retailer, or just inform the retailer of their intent to visit soon. The Consumer may also inform the retailer what products/services they are interested in. Optionally, the Retailer can confirm the Consumer's visit, suggest another visit date/time, or ask other questions to enable a positive visit experience.

Consumer 140, aware that the retail establishment 100 participates in the UICS, enters the store and proceeds to the UICS Concierge Kiosk 112 (FIG. 7), opens the UICS Concierge app and scans the UCIS KIOSK Tag 110. Consumer 140 thus downloads the respective Unique Indicia Concierge App from App Store to their smartphone 142 (FIG. 4), tablet 144 or PC 146 and by doing so Registers their App with the stores UICS System by entering a password, personal information, product preference profile, optional personal photo, and optional credit card information to enable in-app, and in-store purchase and payment.

The consumer's app sends the kiosk indicia number obtained from the scan, and the consumer app number to the UICS system. (the system now knows the consumer is at kiosk 112). The UICS immediately sends a message to the Store Control Computer 102 informing the store that the consumer has arrived. The UICS and also sends a message to the designated Concierge Salespersons Device 122 (FIG. 3) alerting them that the Consumer has arrived at Kiosk 112 (FIG. 7). (the consumers message, personal preference profile and personal photo appears on the salesperson's device screen). The Concierge Salesperson proceeds to the Kiosk area, recognizes the Consumer from their Optional Personal Photo, greets and accompanies the consumer to the desired product/service area. After completing their purchase(s) consumer 140 can effect payment utilizing UICS.

Unique Indicia Concierge Security System (UICSS)

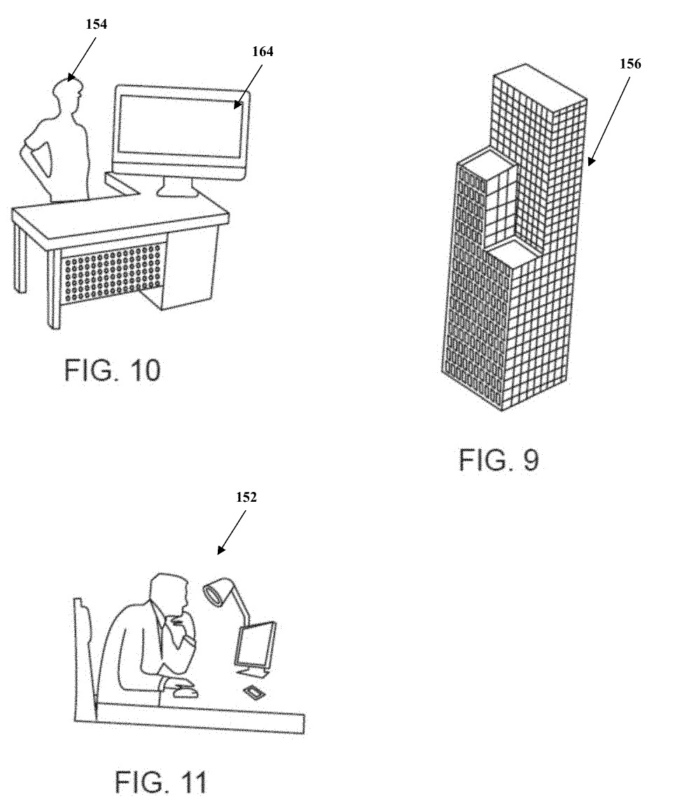

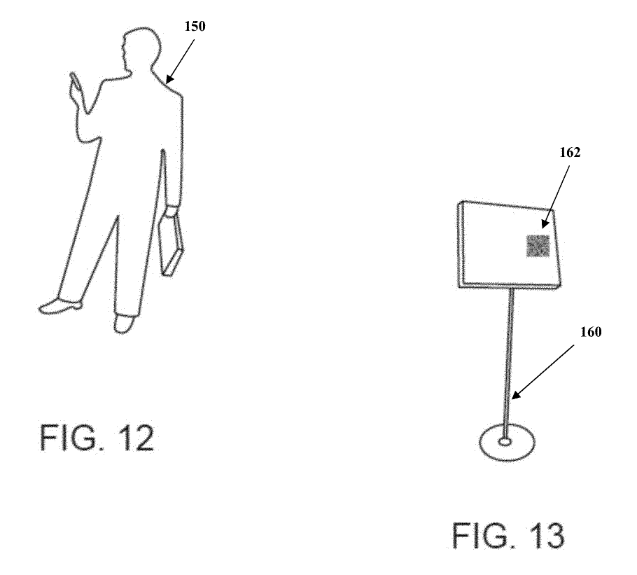

In this innovative embodiment example it will be shown how the UICSS facilitates a secure meeting between guest 150 (FIG. 12) and a host 152 (FIG. 11) through an expedited check-in process witnessed by a security guard 154 (FIG. 8) once the guest arrives at the secure building 156 (FIG. 9) for a meeting.

The described UICSS innovation delivers multiple functions, including:
Scheduling—planning of events and/or appointments;
Arrival—announcing appearance and check in when reaching UICSS enabled business;
Queuing—holding a place in line after arrival at the place of business;
Drop-off—creating a receipt when items are left for services;
Pick-up—quickly identifying yourself to retrieve new orders or items left for drop-off;
Verifying personal identity—providing a security profile to expedite check in;
Payment—for the purchase of goods and services at participating businesses;
Exit or leaving—alerting others and check-out after one has left a business or event.

Parties 150 involved in a UICSS Security check in a secured building or office 156, or other secured place of business are usually: a security guard or company 154 currently hired to facilitate securing the property 156, a host 152 who works for a company within the building 156 and a guest 150 who works outside of the building and needs to gain security access in order to meet with the host 152 on the building property 156. Often such a meeting results after a host invites a guest to a meeting at the host's office in a secured building. The host may also provide a copy of the invitation to the UICSS. The guest may also receive an email from the host with the event details. This email may also have notification instructions that a UICSS Security check-in is available at the host's building with additional instructions as to how to use the app for entrance included. UICSS Security System may also track the meeting details and provide information to the building security Guard or company.

Upon entering the secure building 156 the guest 150 need not meet face to face with the security guard to provide an identity check and reasons for entering the building; but, instead, locates the UICSS kiosk 160 (FIG. 13), and using the UICSS App on their smartphone scans the Kiosk UICSS Tag 162 to announce their arrival and initiate the security check-in process. The security guard 154 receives a notification on their computer screen or tablet that the guest 150 has arrived. The guard 154 addresses the guest and begins the process of checking them in through the UICSS Security System. To do so the guard 154 may follow the prompts on the screen of a computer 164 (FIG. 10) to verify the guest's credentials and grant the guest access to the secure areas of the building 156. Simultaneously the host 152 will receive a notification via email or on their smartphone app that the guest 150 has entered the building 156. The host 152 may also be prompted to meet their guest 150 in the lobby of the building 156 or at the entry to the hosts office or, possibly, have a secretary or other of the hosts personnel meet the guest and escort them to the host for their meeting.

It should be readily seen from the above detailed description that the Consumer app is private and secure. That the privacy of consumers, merchants and brands is respected and can be guaranteed since no information is to be shared with any third party beyond the direct participants in a specific transaction.

Any reference to System Users is by way of example and is intended to include any consumer, purchaser of an item or items, whether the item is to be consumed or merely to be employed for use with other items; and to service or services regardless of what the service or services is or how it is to whether alone or with other services. Similarly the reference to Service Provider is by way of example also and is to include, merchants, retailers, wholesalers, jobbers, manufacturers, travel agents, hotel and restaurant personnel, security personnel and guards, etc.

In the preceding system descriptions, reference is made to smartphones and computers. A wide range of smartphones, tablet computers, personal computers, laptops and desktop computers have Internet, Wi-Fi, and mobile cellular communications capability. Any of these digital devices can be used interchangeably for all of the functions described above, whether by Consumers or Retailer Management and Staff. Most of these devices also have GPS tracking capability, which can enhance and facilitate many of the transactions described above.

The UICS and UICSS is preferably configured as a “cloud based” management information system. The systems generate unique indicia-based identifiers for each System User and Service Provider each kiosk, each concierge salesperson, each management staff or support person.

The UICS and UICSS systems organize and store all the unique identifiers, and records all associated transactions, and transaction content. This data is segmented and partitioned to insure privacy between all individual consumers and all individual participants.

The UICS system stores all kiosk visit requests, and sends out appropriate alerts to all necessary participants in any transaction. A history of any and all commercial and social interactions between participants is stored and available to facilitate and improve future consumer needs, desires and experiences. It is anticipated that all data transmissions will protected with the latest encryption and data storage protection technology to assure the privacy of all participants.

In the UICS and UICSS every person, business, business location, business transaction, (everything of importance), is given a unique universal identifier as part of a secure communication/transaction system. These Unique “tags” when applied to physical things like products, posters, or locations can be scanned with smartphones. When representing physical things, transactions, events, or virtual objects, the Unique Tags can be addressed by digital devices like computers, servers, etc. as part of a System “in the cloud”.

A key component of the UICS is a universal, multipurpose Smartphone App that makes everyday interactions with businesses easier and more convenient. Scheduling, Arrival Queuing, Drop-off, Pick-up, Verifying personal identity, Payment and Exit or leaving.

Some High Value Early Target UICS and UICSS applications include: Commercial UICS Applications such as; building security admission/check in, making or accepting an appointment, and quick notice of arrival (enables speedier entrance while maintaining security). Restaurant Dining may include: making reservations and/or signaling arrival for reservation; placing a person or persons in line for a table, expected waiting time, notification that your table is ready; verification of ID for alcohol purchase(s) and bill payment. Retail may include: making an appointment; announcing arrival; requesting personal assistance; and obtaining a store map/search for ease of product location.

Additional UICS and UICSS applications, for hotel involvements may include: check-in; virtual room key; payment and check-out. Take-Out of food like: ordering remotely; paying before arrival; and signaling arrival. For stadium or theater events: ticket purchasing; admission to the venue and ordering food from a seat.

Transportation/Travel Related UICS and UICSS applications include: car rentals; pickup or drop-off and payment; car repair/service; scheduling; arrival, drop-off; payment; parking; car park entry & exit & each parking space (assisting in finding car in garage; valet parking; parking meter payment; toll booth payment; payment at gas pump; cabs with, getting in and out; payment; retrieval of items left in cab. For subway and busses: payment; getting on and off; return of items left in transit and a package receipt.

Commercial UICS and ICSS applications include: Real Estate Open House Registry; cash machine; personal care, like barber and beauty shops; as well as dry cleaning/laundry/alterations; new customer ID arrival and pickup; picking up and orders for photos; eyeglasses; prescription pick up. For medical matters there is doctor or dentist office visits; scheduling appointments; signaling arrival; emergency room visits; signaling arrival for the visits; outpatient services at hospital or clinic-signaling arrival and to verify identify. For senior homes—check-in, check out and escort patients for outside trips. and parents tracking of minor children.

Other UICS and UICSS applications include: attendance rolls; employee time clocks; parties; tour groups on the move; airport security; airline tickets/boarding; museum commentaries; road side historic site commentaries; amusement park stratified admissions; leaving safe area and arrival back-harbor and trail head.

It is understood that although there has been shown and described preferred embodiments of this invention that various modifications may be made in the details thereof without departing from the spirit as comprehended by the following claims.

What is claimed is:

1. A concierge system for a person seeking products and/or services from a predetermined business establishment or establishments; comprising,
(a) at least one electronic device for the person to receive a predetermined unique concierge software;
(b) at least one special ID tag carrying an encoded ID indicating that a predetermined business establishment offers said unique concierge service for said predetermined products and services;
(d) said business establishment displaying said special ID tag at a predetermined business location or locations for viewing by a person seeking products and or services;
(e) whereby said person may utilize their electronic device to capture the special ID of the predetermined business establishment to indicate their presence at the predetermined business establishment.

2. The concierge system of claim 1 whereby the predetermined business establishment, upon receiving an indication that a person seeking products and/or services is in attendance, may provide a representative to the person to assist the person with their endeavors.

3. The concierge system of claim 1 including at least one kiosk which displays said special ID.

4. The concierge system of claim 3 including a plurality of said kiosks deployed at various predetermined locations throughout the business establishment.

5. The concierge system of claim 4 wherein said special ID for said kiosks may also indicate the predetermined products and/or services provided at the location where said kiosk is located.

6. The concierge system of claim 1 wherein the business establishment is a secure building, office or other place of business and said special ID tag is to facilitate entry of a person into the secure building, office or other place of business.

7. The concierge system of claim 2 wherein the business establishment is a retail store and the representative is a salesperson.

8. The concierge system of claim 7 wherein said salesperson is provided with an electronic device which is to receive an indication that a person is in attendance and may also indicate the persons purchase preferences.

9. The concerge system of claim 1 wherein the person may utilize the system to effect payment for selected products and/or services.

10. The concierge system of claim 1 wherein the person may utilize the system to make reservations for various places and kinds of business.

11. A process for providing a concierge-like service for a person seeking products and/or services from a predetermined business establishment or establishments; comprising,
(a) providing at least one electronic device for a person to receive a predetermined unique concierge software;
(b) providing at least one special ID tag carrying an encoded ID indicating that a predetermined business establishment offers said unique concierge service for its products and services;
(c) whereby capture and downloading of the encoded ID of the special ID tag provides an indication of interest in a particular businesses products and/or services and facilitates interaction of the person and a selected business.

12. The process of 11 including providing a representative or representatives upon receiving an indication that there is a person seeking products and/or services.

13. The concierge process of claim 11 including providing at least one kiosk to display said special ID.

14. The concierge process of claim 13 including providing a plurality of said kiosks to be deployed at various predetermined locations throughout a business establishment.

15. The concierge process of claim 14 wherein said special ID for said kiosks may also include locating the special ID Kiosks at locations for the predetermined products and/or services provided at the location where said kiosk is located.

16. The concierge process of claim 11 wherein the business establishment is a secure building, office or other place of business and said special ID tag is to facilitate entry of a person into the secure building, office or other place of business.

17. The concierge process of claim 12 wherein the business establishment is to be a retail store and the representative is to be a salesperson.

18. The concierge process of claim 17 wherein said salesperson is provided with an electronic device which is to receive an indication that a person is in attendance and may also indicate the persons purchase preferences.

19. The concerge process of claim 11 wherein the person may utilize the system to effect payment for selected products and/or services.

20. The concierge process of claim 11 wherein the person may utilize the system to make reservations for various places and kinds of business.
